(19) United States
(12) Patent Application Publication
(10) Pub. No.: US 2023/0085994 A1
(43) Pub. Date: Mar. 23, 2023

(54) LOGICAL RESOURCE PARTITIONING VIA REALM ISOLATION

(71) Applicant: Intel Corporation, Santa Clara, CA (US)

(72) Inventors: Ramya Jayaram Masti, Hillsboro, OR (US); Thomas Toll, Portland, OR (US); Barry Huntley, Hillsboro, OR (US)

(73) Assignee: Intel Corporation, Santa Clara, CA (US)

(21) Appl. No.: 17/478,811

(22) Filed: Sep. 17, 2021

(51) Int. Cl. G06F 21/53; G06F 21/55; G06F 21/54; G06F 9/50; G06F 9/46

(52) U.S. Cl. CPC G06F 21/53; G06F 21/554; G06F 21/54; G06F 9/5016; G06F 9/5077; G06F 9/467

(57) ABSTRACT

Methods and apparatus relating to logical resource partitioning via realm isolation are described. In an embodiment, a logic processor, to be assigned to one of a plurality of processor cores of a processor, executes one or more operations for at least one of a plurality of logical realms; The plurality of logical realms include a security monitor realm and the security monitor realm includes security monitor logic to maintain a Realm Identifier (RID) for each of the plurality of logical realms. The security monitor logic controls access to each of the plurality of realms based at least in part on the RID for each of the plurality of logical realms. Other embodiments are also disclosed and claimed.

### FIELD

The present disclosure generally relates to the field of electronics. More particularly, an embodiment relates to logical resource partitioning via realm isolation.

### BACKGROUND

Many-core processors with very large core counts require mechanisms to isolate the impact of bugs and vulnerabilities in system management software. Currently, such processors may support the use of a single instance of system management software such as the Virtual Machine Monitor (VMM). As a result, this single instance of system software that may manage a large number of workloads becomes a single point of failure; and such failure could potentially affect all the active workloads in the system.

Furthermore, usage models in which cloud service providers offer dedicated hardware resources to individual customers become impractical as core counts increase beyond the requirements of individual customers.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of how a monolithic processor with memory can be partitioned into several partitions, according to an embodiment.

FIGS. 2A and 2B illustrate block diagrams of how processor cores and memory can be isolated, according to some embodiments.

FIG. 3 illustrates a block diagram of a system with logical resource partitioning via realm isolation, according to an embodiment.

FIG. 4 illustrates a block diagram of a realm-aware IOMMU (input-output memory management unit), according to an embodiment.

FIG. 5 illustrates a flow diagram of a method to provide logical resource partitioning via realm isolation, according to an embodiment.

FIG. 6A is a block diagram illustrating both an exemplary in-order pipeline and an exemplary register renaming, out-of-order issue/execution pipeline according to embodiments.

FIG. 6B is a block diagram illustrating both an exemplary embodiment of an in-order architecture core and an exemplary register renaming, out-of-order issue/execution architecture core to be included in a processor according to embodiments.

FIG. 7 illustrates a block diagram of an SOC (System On Chip) package in accordance with an embodiment.

FIG. 8 is a block diagram of a processing system, according to an embodiment.

FIG. 9 is a block diagram of an embodiment of a processor having one or more processor cores, according to some embodiments.

FIG. 10 is a block diagram of a graphics processor, according to an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, a single instance of system software (e.g., VMM) that manages a large number of workloads becomes a single point of failure; and, such failure could potentially affect all the active workloads in the system. Furthermore, usage models in which cloud service providers offer dedicated hardware resources (such as processors, memory, Input/Output (10) devices also referred to as bare-metal instances) to individual customers (e.g., in order to provide better security and availability guarantees) become impractical as core counts increase beyond the requirements of individual customers.

To address these issues, some embodiments provide one or more techniques for logical resource partitioning via realm isolation. As discussed herein, a “realm” generally refers to a grouping of one or more components into an independent execution environment. In an embodiment, a logical partitioning scheme for many-core processors is provided which allows for the existence of multiple system management software instances, each potentially controlled by a completely independent entity. This, in turn, limits the impact of bugs or faults in a single system software instance as well as allows the co-existence of multiple whole bare-metal stacks (e.g., VMM, its Virtual Machines (VMs), and their workloads), while still guaranteeing strict (e.g., operational) isolation among them.

Moreover, the problem of partitioning a processor among multiple independent VMM instances is of real interest, in part, because a single VMM managing all the workloads on a large-core count processor increases the blast-radius of (or the number of affected cores by) potential bugs and vulnerabilities. The resulting updates and reboots affect a large number of cores/workloads requiring migration of all workloads prior to update/reboot. Furthermore, the growing core-counts in modern processors makes them hard to use as-is for bare-metal/dedicated instances. Therefore, there is a lot of interest in techniques to partition a large number of cores into smaller groups and assign each such group to a different customer as a bare-metal instance. One or more embodiments described herein enable such usages.

Additionally, one or more embodiments could also enable new features such as memory hot-plug for TDX (trusted domain extensions, such as provided by Intel® Corporation of Santa Clara, Calif.), bootless updates for requiring a full system teardown, etc.

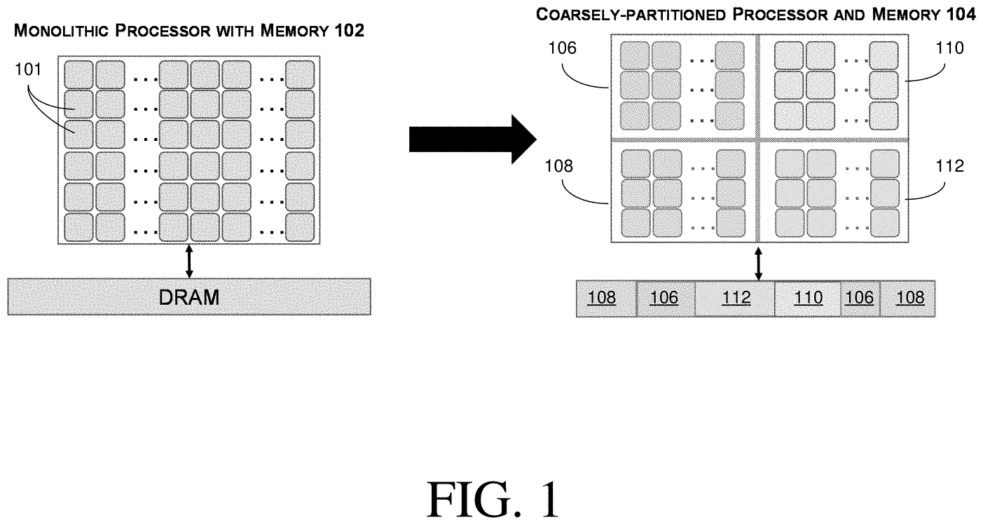

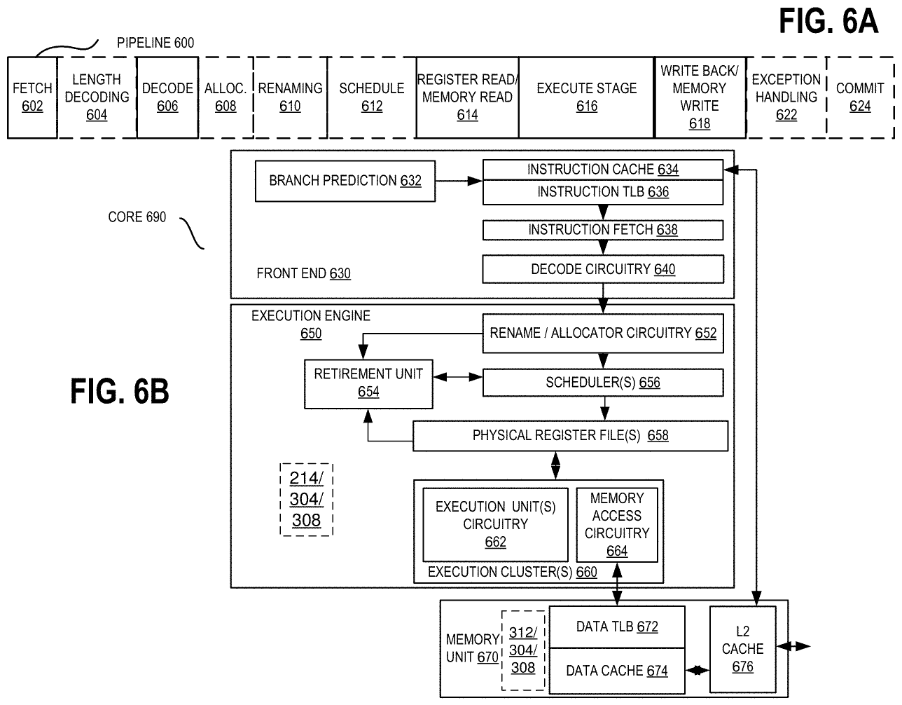

FIG. 1 illustrates a block diagram of how a monolithic processor with memory can be partitioned into several logical partitions, according to an embodiment. As shown in FIG. 1, a monolithic processor (having a plurality of processor cores 101) with memory 102 is partitioned into a coarsely-partitioned processor with memory 104. While the memory is shown as DRAM (dynamic random access memory) other types of memory may be used, such as those discussed with reference to FIG. 6A et seq. including, for example, Static Random Access Memory (SRAM), flash memory, 3-Dimensional Cross Point Memory (3D XPoint, such as PCM (Phase Change Memory)), Resistive Random Access Memory, Magnetoresistive RAM, Spin Transfer Torque RAM (STTRAM), etc.

Referring to FIG. 1, hardware partitions 106, 108, 110, and 112 may be managed as independent systems. For example, each partition may be treated as equivalent to a bare-metal instance (e.g., is capable of running a CSP's VMM). As a result, negative effects of software bugs and vulnerabilities can be contained or at least reduced. Each partition can be updated and administered independently. Software hand-offs may enable transitions of workloads/cores/memory across partitions. Partitions can also be used to enhance system RAS (Reliability, Availability, and Serviceability) by allowing faulty cores or memory regions to be re-allocated/isolated/mapped out to an unused “inactive” partition, effectively removing them from the pool of available system resources. Likewise, the Security Monitor may choose at boot time to initially allocate certain cores or memory to an unused “spare” partition and then later re-allocate them to other partitions as necessary to replace other cores or memory that are no longer operating reliably. This could be done for example by the Security Monitor reserving a set of cores that it never allocates to other partitions and therefore, are never visible to them. These cores could remain idle (e.g., in a low power state or standby) or be used by the monitor itself for better performance until re-allocated to make up for other faulty cores.

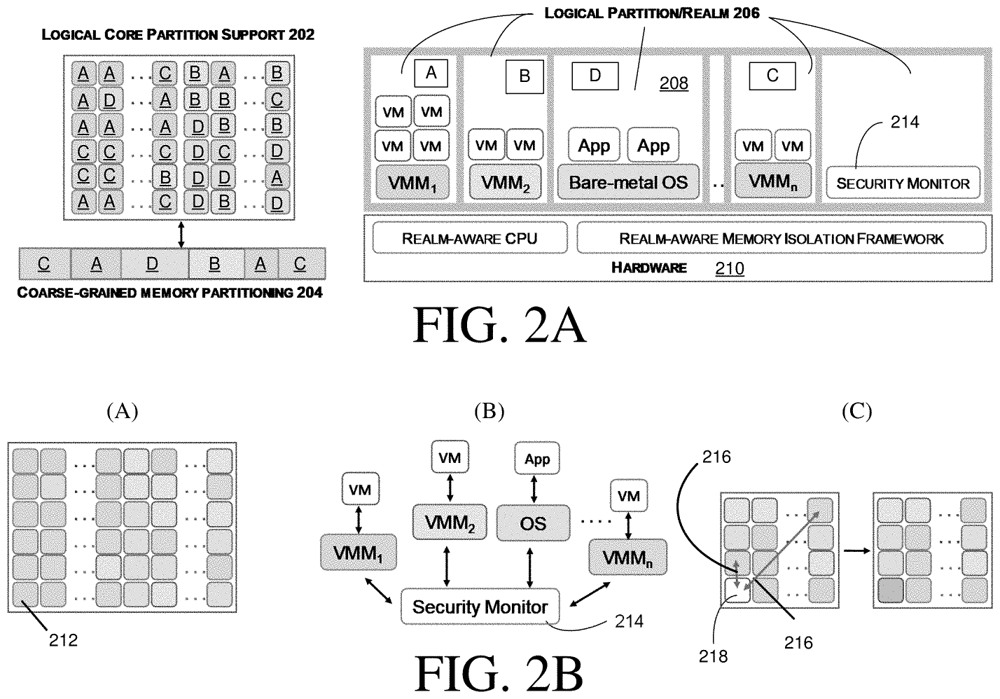

FIGS. 2A and 2B illustrate block diagrams of how processor cores and memory can be isolated, according to some embodiments. More particularly, these figures show how cores and memory isolation can be achieved among multiple co-existing VMMs and/or bare-metal OSes (operating systems). In the shown examples, FIG. 2A illustrates a light-weight logical partitions/realms (e.g., an intermediate step) and FIG. 2B illustrates a realm-aware CPU (central processing unit) or processor.

At least one embodiment limits the impact of bugs or vulnerabilities in the VMMs or OSes and prevents them from affecting all the workloads (and hence, all threads/cores) on the platform. As discussed herein, reference to VMM, OS, or bare-metal instance/OS are intended to refer to a system software stack or independent software stack. This is unlike the current situation where a single VMM manages the entire platform and is therefore a single point of failure, and a single error can take down all running workloads across potentially hundreds of cores/threads. Further, an embodiment allows logical core partition support 202 and coarse-grained memory partitioning 204 for multiple VMMs 206 and/or bare-metal instances 208 to co-exist on the same hardware 210. These distinct, isolated portions (e.g., software stacks) can potentially belong to different customers/users and can operate completely independent of each other. So, a bug/vulnerability that crashes a given VMM or bare-metal instance will not affect the workloads that are managed by other VMM or bare-metal instances.

In FIGS. 2A, 2B, 3, and 4, items in the same partition/realm are marked with A, B, C, and D for ease of reference. As shown in FIG. 2B(A), each core 212 shall belong to a single realm at any given point of time. This assignment of core realm is done by security monitor logic 214 (shown in FIGS. 2A and 2B(B)). As illustrated in FIG. 2A, the security monitor 214 may run on any core and use a dedicated realm (e.g., as shown by a separate box (i.e., co-existing with VMM and bare-metal OS realms)). Each realm may constitute its own logical coherence domain.

Referring to FIG. 2B(B), cross-realm transitions/communication (which should be rare) are mediated/managed/facilitated by the security monitor 214. Inter-realm transitions/communication can be performed (e.g., automatically) through the correct/corresponding VMM/OS for that realm.

In one embodiment, such as shown in FIG. 2B(C), Inter-Processor Interrupts (IPI) 216 (e.g., available only to the security monitor 214) can force other processor cores to transition realms. In an embodiment, a processor core 218 may be dedicated for the security monitor 214 to guarantee availability. Alternatively, a processor core may be allocated temporarily to the security monitor 214 on a periodic basis (e.g., via a watch dog process or periodic timer-based interrupt).

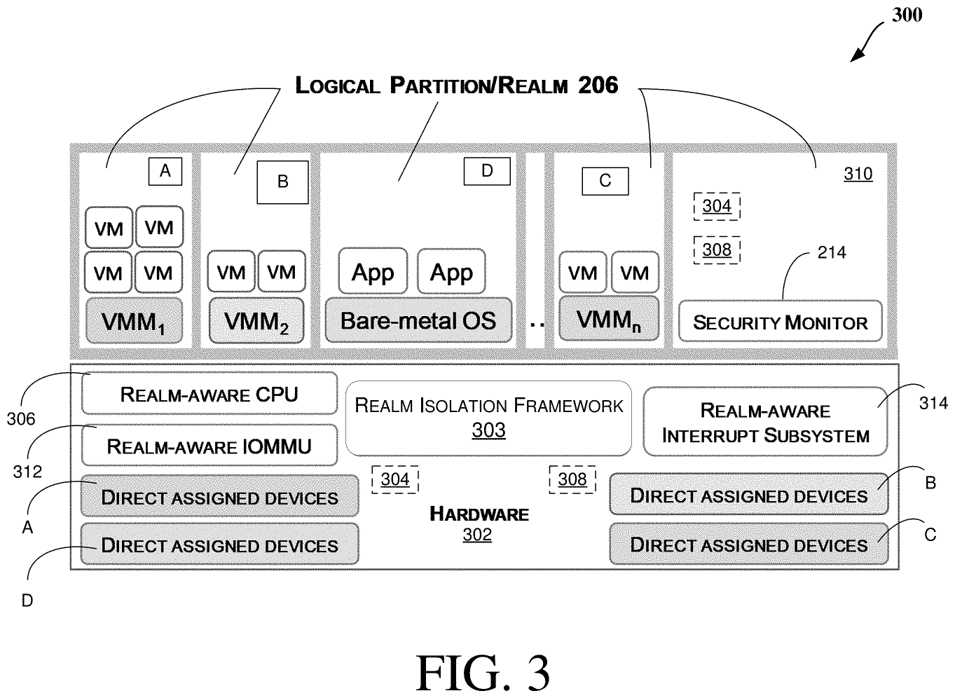

FIG. 3 illustrates a block diagram of a system 300 with logical resource partitioning via realm isolation, according to an embodiment. System 300 includes components that are the same or similar to those discussed with reference to FIGS. 1-2B. For example, the security monitor logic 214 can directly assign devices to each realm as shown in FIG. 3, using references A-D referring to the grouping of various direct assigned devices to corresponding realms 206. VMM or OS in each realm 206 can administer its devices independently without run-time support from the security monitor logic 214 in at least one embodiment.

Referring to FIG. 3, hardware 302 supports the logical partitioning of the realms 206. To provide a realm separation/isolation framework 303, which allows the co-existence of multiple (e.g., coherent) realms 206, isolation among the realms is maintained in the processor cores, caches, and in memory through the use of a Realm Identifier (RID) that may flow (or is otherwise communicated or available) with all physical or system addresses and is used to tag the data caches in the system. The correct, reference RID (RID_{ref}) for a particular memory address is stored in an access control data structure 304 that is programmed by the security monitor logic 214. In one embodiment, the access control data structure 304 is implemented as one or more tables. In an embodiment, the access control data structure 304 is located in the same realm as the security monitor logic 214 (e.g., as shown in FIG. 3), but embodiments are not limited to this and the access control data structure 304 may be located elsewhere in the system, such as those shown in FIG. 3 et seq. This data structure is used/accessed by hardware and/or software to determine ownership of a system resource (e.g., memory, cache lines, etc.) in order to ensure that requests originating from a given realm are only allowed to access the resources belonging to that same realm.

Hardware 302 includes a realm-aware processor (or CPU) 306. In an embodiment, each memory transaction is associated with a request RID (RID_{req}). In another embodiment, each hardware thread (e.g., logical processor) is associated with an RID depending on its execution context, which is maintained in a current RID (RID_{curr}) register 308. As discussed herein, a “logical processor” generally refers to a processor thread or processor core to which a task or thread may be assigned. In some embodiments, a single physical processor core is capable of simultaneously handling multiple threads (such as some Intel® processors with hyper-threading). While register 308 is shown to be optionally located in the security monitor realm 310 and/or hardware 302, register 308 may be located elsewhere that is accessible by the security monitor 214. The logical processor may be enhanced to support multiple VMMs. This allows every logical processor to be assigned to any realm over time and/or during runtime.

Each realm 206, except the security monitor realm 310, can be used to run a completely independent VMM that can, in turn, run its own VMs such as shown in the figures. In an embodiment, the security monitor realm 310 is privileged and used to securely manage and isolate the software belonging to all the other realms as further described herein.

The security monitor realm 310 operates as a peer to all other realms in the system and serves as a key component of the privileged software TCB (trusted computing base) of the system. Hence, the security monitor realm 310 (or security monitor logic 214) can configure the access control structure 304 (e.g., in memory or other storage medium such as those discussed with reference to FIG. 6A et seq.) containing RID_{ref} information for every physical memory address. A system may support maintaining this information at multiple granularities, and supported granularities may vary from one implementation to another. In some implementations, RID_{ref} assignment granularity is expected to match one or more of the supported page sizes (e.g., 4 KB, 2 MB, and/or 1 GB).

Cross-realm transitions are mediated by the security monitor logic 214 as discussed with reference to FIG. 2B. Special transitions that are denoted by VMM_Entry and VMM_Exit requests/instructions/operations can be used to control transfers between the security monitor logic 214 and the VMM running within a different realm. During VMM_Entry operation(s) (e.g., to enter a VMM), the processor 306 may configure the RID corresponding to the target execution context in the RID_{curr} register 308. Similarly, during the VMM_Exit operation(s) (e.g., to exit a VMM), the RID_{curr} is re-programmed (e.g., by the processor 306) with the RID of the security monitor realm 310. In some embodiments, there is one RID_{curr} register per logical processor and its value is used to tag all memory transitions generated by the software running on that processor.

Besides the VMM_Entry and VMM_Exit instructions, RID_{curr} can be modified directly only by the security monitor logic 214 itself. This allows the security monitor logic 214 to access memory belonging to all the realms in the system. VM_Entry and VM_Exit instructions/operations between a VMM and its VMs do not affect the RID_{curr} value. Alternatively, the processor 306 could be enhanced to support transitions directly among the various realms without intervention by the security monitor logic 214. In this case, the processor 306 programs the RID_{curr} across transitions to ensure that the incoming VMM/realm has access to the correct set of resources (e.g., memory, interrupts, etc.).

In a simplified IO model, the security monitor logic 214 also assigns entire hardware devices exclusively to a single realm in an embodiment. In another embodiment, the security monitor logic 214 allows multiple realms to share a given device by allocating at the granularity of the individual assignable interface that the device exposes. In the latter case, the security monitor logic 214 (or realm 310) is still responsible for the administration of the device (e.g., managing the physical function of a virtualization-capable Peripheral Component Interface express (PCIe) device). Supporting either of these models relies on the use of a realm-aware IOMMU (input-output memory management unit) as further discussed herein.

More particularly, hardware 302 includes a realm-aware IOMMU 312 as shown in FIG. 3. In an embodiment, every memory transaction includes a RID_{req} as part of the request, and the IOMMU resolves the RID during the memory translation processing. In the simplified model (where an entire device is assigned to a single realm), the IOMMU tracks which bus:device pairs are mapped to which realm with the help of the security monitor logic 214. As discussed herein, “bus:device” generally refers to the physical location of the device on the many available physical buses (e.g., as used in PCIe). More specifically, the security monitor logic 214 may configure the mapping between devices and their realms either by extending existing IOMMU data structures (e.g., context tables) or by creating entirely new data structures for the IOMMU to parse. For every incoming IO transaction that targets memory, the IOMMU 312 looks up the RID and forwards it as part of the memory request (or stores it in a storage unit that is accessible by the security monitor logic 214). Any existing caches (e.g., context cache) may be extended to hold the RID. Similarly, if new data structures are used to maintain the mapping between devices and RIDs, then new caches may be added to the IOMMU 312 to store this information for optimized performance.

In another embodiment, the security monitor logic 214 maintains a mapping between the different assignable interfaces of each device and the realm to which it is assigned. This could be done by extending the existing IOMMU data structures (e.g., PASID (physical address space identifier) table entries) or by adding entirely new data structures that the IOMMU may utilize to determine this mapping. The corresponding caches (e.g., PASID cache) may be extended to hold the RID or new caches may be added to store this mapping information.

As shown in FIG. 3, hardware 302 may also include a realm-aware interrupt delivery subsystem 314. Since interrupts provide a mechanism through which processors can interact with each other as well as shared external devices, a logically partitioned system 300 provides the ability for the security monitor logic 214 to control the sending and/or delivery of interrupts within the system.

More particularly, the realm-aware interrupt subsystem 314 (which may also be referred to as realm-aware interrupt delivery system) supports three classes of interrupts in some embodiments. First, local interrupts are generated in response to events that occur within the context of a logical processor (e.g., timer or performance monitoring). These interrupts are delivered to the logical processor that triggered them. As such, local interrupts naturally route to the correct RID and so the only special requirement imposed by the logical partitioning architecture is for the security monitor logic 214 to make sure that all corresponding interrupt (e.g., APIC (Advanced Programmable Interrupt Controller) LVT (Local Vector Table)) entries are disabled and any pending local interrupts have been delivered to the current realm before initiating a realm switch.

Second, Inter-Processor Interrupts (IPIs) are sent from any logical processor to any other logical processor in the system, per existing APIC hardware. In order to provide IPI isolation across realms, the APIC hardware can be extended so that the security monitor logic 214 can block the sending and/or delivery of interrupts across realms. Options include: (1) IPIs always trigger a realm switch to the security monitor logic 214, which then takes responsibility for delivering the IPIs as appropriate; (2) the security monitor logic 214 configures the APIC on each logical processor with a list (e.g., bit vector) of APIC IDs that are assigned to the same realm (any attempt to send an IPI to a logical processor that is not included in this list is blocked; optionally, resulting in an error condition/signal generation); and/or (3) the IPI is sent with a copy of the originating processor's RID_{curr}. Upon receipt at the destination APIC, the interrupt's source RID_{curr} is compared to the recipient's RID_{curr} (if they match, the IPI is delivered; otherwise, the IPI is dropped and possibly logged as an error, e.g., with a generated error signal).

Third, external Interrupts can be generated by IO devices. Namely, in addition to memory requests, IO devices can also generate interrupt requests. As with IO memory requests, the security monitor logic 214 makes sure that interrupt requests from external IO devices are routed to the appropriate realm. This can be done in two ways:

(1) the security monitor logic 214 could program the Interrupt Remapping Table (IRT) to contain the correct RID along with the destination ID as part of every entry. When the IOMMU 312 fetches and issues the interrupt to the destination processor, the processor in turn first switches to the correct realm and then handles the interrupt. Alternatively, there could be one or more designated logical processors in or assigned to every realm that handles interrupts for that realm and the security monitor logic 214 can program each IRT entry to target the correct logical processors based on the realm to which the entry belongs.

(2) The security monitor logic 214 could maintain one Interrupt Remapping Table per realm. The security monitor logic 214 then divides the available interrupt vector space among the various realms by reserving the upper bits to use as a RID. Whenever an interrupt occurs, these upper bits are used to decide which Interrupt Remapping Table to index for further interrupt processing. The IOMMU 312 could implement additional logic to ensure that only devices belonging to a given realm can generate interrupts into that realm. This could be achieved by using the security monitor logic 214 (or other logic) to maintain the owner realm for every device in the system and checking that the interrupts generated by each device is within the correct range.

IPIs and external interrupts could also be handled by a dedicated interrupt handler realm (not shown) that is responsible for routing of interrupts to their correct destination realm. In this case, any IPI or external interrupt would cause a switch to the interrupt handler realm that in turn would transfer control to the correct destination realm to handle that interrupt.

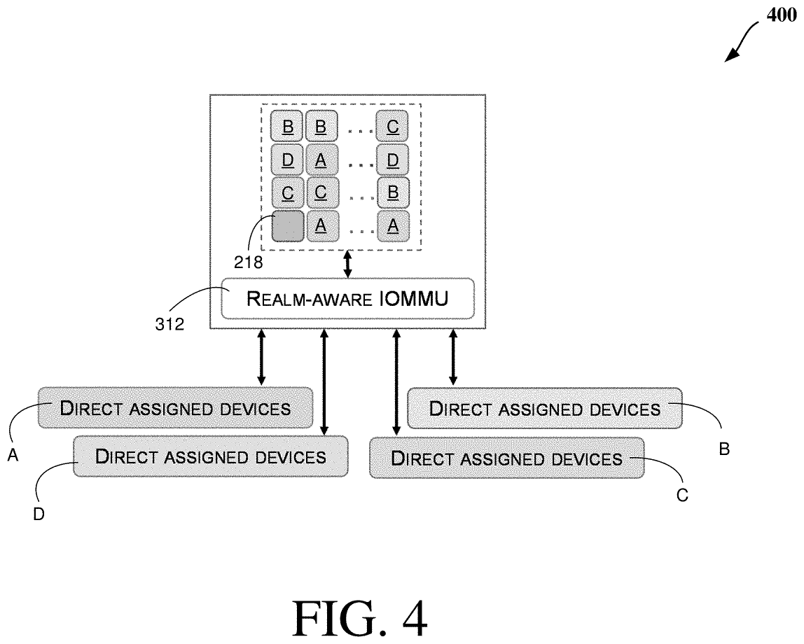

FIG. 4 illustrates a block diagram of a realm-aware IOMMU (input-output memory management unit) 400, according to an embodiment. In one embodiment, the IOMMU 400 is the same or similar to the realm-aware IOMMU 312 of FIG. 3.

Security Monitor programs new IOMMU structures to assign each device on a bus or interconnect coupled to the IOMMU 400 to a realm. In an embodiment, each VMM/OS sets up VT-d (Virtualization Technology for Directed 10, e.g., provided by Intel® Corporation of Santa Clara, Calif.) structures for devices it owns or supports. IOMMU may use bus:device to realm mapping to decide which VMM structures to walk or review.

Malicious VMM could: (1) setup spurious structures for devices it does not own but they will never be walked by the IOMMU (e.g., because the security monitor maintains the bus:device realm mapping, so as a request is received, a field in the request is used to identify the legitimate realm owner and that owner's tables are walked, so spurious structures from a malicious VMM are never walked); and/or (2) map memory that does not belong to it, but memory isolation framework described herein protects against cross-realm memory accesses.

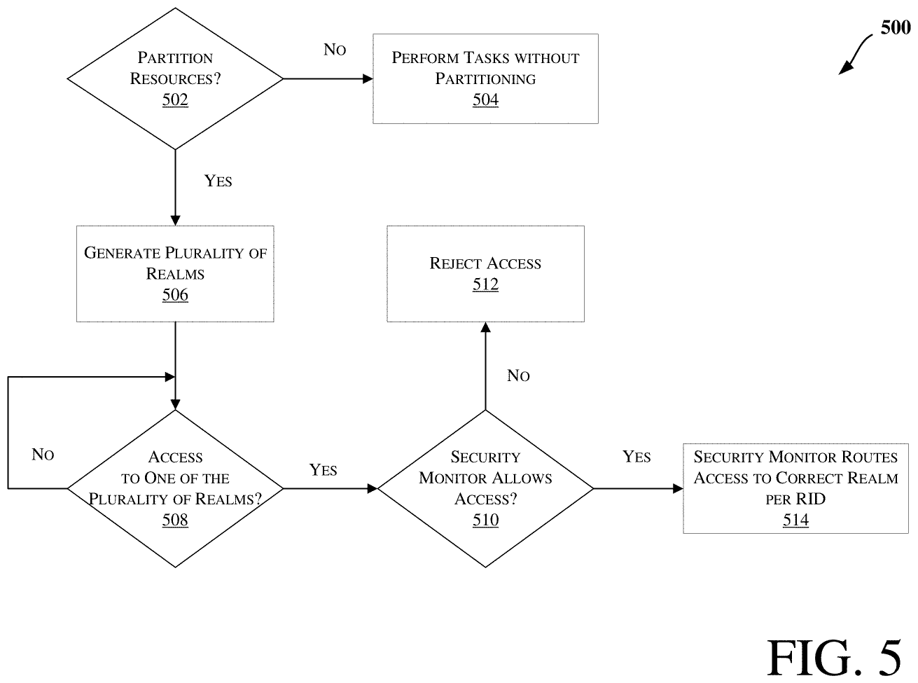

FIG. 5 illustrates a flow diagram of a method 500 to provide logical resource partitioning via realm isolation, according to an embodiment. One or more of the operations of method 500 may be performed by the components discussed with reference to FIGS. 1-4 and/or 6A-10 as further discussed below.

Referring to FIGS. 1 through 5, operation 502 determines whether logical resources are to be partitioned ((e.g., performed in response to a request to partition that may be directed via a command or instruction to one of the processors discussed herein). If no partitioning is requested, operation 504 performs task(s) without partitioning; otherwise, operation 506 (e.g., performed by the processor 306) generates a plurality of logical realms such as realms 206.

Operation 508 (e.g., performed by processor 306 and/or logic 214) determines whether there is access to one of the plurality of realms generated at operation 506 and if so, operation 510 (e.g., performed by logic 214) determines whether access is allowed. If access is not allowed, operation 512 rejects the access, e.g., by generating an error signal; otherwise, operation 514 (e.g., performed by the security logic 214) routes the access to the correct realm per the corresponding RID, such as discussed with reference to FIG. 3.

Accordingly, one or more embodiments include one or more of the following components: (1) a realm separation framework that allows the co-existence of multiple realms on the same platform; (2) a realm-aware processor/core that supports the existence of multiple VMMs and/or OSes concurrently (each thread of execution on the processor/core could belong to a different realm, and hence, be managed by a different VMM or OS); (3) a security monitor realm (with a security monitor logic) that configures the access control structures used for realm separation, including the table(s) containing mappings of memory regions to their assigned RIDs and IO data structures used by the IOMMU to enforce realm separation for IO transactions; (4) a realm-aware IOMMU that is enhanced to resolve the RID for incoming IO transactions that target memory; and/or (5) a realm-aware interrupt delivery system that ensures that the various interrupts are routed correctly to their respective realms.

Moreover, solutions that use a hypervisor to create logical partitions are designed primarily to run on operating systems, such as Microsoft Windows® and Linux®. Using them to run VMMs/hypervisors will require the use of nested virtualization which is not efficient in terms of complexity and performance. Additionally, unlike multi-hypervisor (also sometimes referred to as “MultiHype”) solutions, at least one embodiment allows flexible and/or dynamic assignment of cores to different realms. In fact, various embodiments enable independent threads of execution belonging to different realms to run on a single core. This contrasts with multi-hypervisor implementations where the mapping of cores to realms is static and more coarse-grained. To enable this flexibility, one or more embodiments include processor extensions (e.g., security monitor logic 214 and/or other components discussed herein with reference to FIG. 1 et seq.) to support the use of multiple hypervisors and ensure the binding between any VM and its underlying VMM/realm.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU (Central Processing Unit) including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

FIG. 6A is a block diagram illustrating both an exemplary in-order pipeline and an exemplary register renaming, out-of-order issue/execution pipeline according to embodiments. FIG. 6B is a block diagram illustrating both an exemplary embodiment of an in-order architecture core and an exemplary register renaming, out-of-order issue/execution architecture core to be included in a processor according to embodiments. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, a length decode stage 604, a decode stage 606, an allocation stage 608, a renaming stage 610, a scheduling (also known as a dispatch or issue) stage 612, a register read/memory read stage 614, an execute stage 616, a write back/memory write stage 618, an exception handling stage 622, and a commit stage 624.

FIG. 6B shows processor core 690 including a front end unit 630 coupled to an execution engine unit 650, and both are coupled to a memory unit 670. The core 690 may be a reduced instruction set computing (RISC) core, a complex instruction set computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front end unit 630 includes a branch prediction unit 632 coupled to an instruction cache unit 634, which is coupled to an instruction translation lookaside buffer (TLB) 636, which is coupled to an instruction fetch unit 638, which is coupled to a decode unit 640. The decode unit 640 (or decoder) may decode instructions, and generate as an output one or more micro-operations, micro-code entry points, microinstructions, other instructions, or other control signals, which are decoded from, or which otherwise reflect, or are derived from, the original instructions. The decode unit 640 may be implemented using various different mechanisms. Examples of suitable mechanisms include, but are not limited to, look-up tables, hardware implementations, programmable logic arrays (PLAs), microcode read only memories (ROMs), etc. In one embodiment, the core 690 includes a microcode ROM or other medium that stores microcode for certain macroinstructions (e.g., in decode unit 640 or otherwise within the front end unit 630). The decode unit 640 is coupled to a rename/allocator unit 652 in the execution engine unit 650.

The execution engine unit 650 includes the rename/allocator unit 652 coupled to a retirement unit 654 and a set of one or more scheduler unit(s) 656. The scheduler unit(s) 656 represents any number of different schedulers, including reservations stations, central instruction window, etc. The scheduler unit(s) 656 is coupled to the physical register file(s) unit(s) 658. Each of the physical register file(s) units 658 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 658 comprises a vector registers unit, a writemask registers unit, and a scalar registers unit. These register units may provide architectural vector registers, vector mask registers, and general purpose registers. The physical register file(s) unit(s) 658 is overlapped by the retirement unit 654 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 654 and the physical register file(s) unit(s) 658 are coupled to the execution cluster(s) 660. The execution cluster(s) 660 includes a set of one or more execution units 662 and a set of one or more memory access units 664. The execution units 662 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 656, physical register file(s) unit(s) 658, and execution cluster(s) 660 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 664). It should also be understood that where separate pipelines are used, one or more of these pipelines may be out-of-order issue/execution and the rest in-order.

The set of memory access units 664 is coupled to the memory unit 670, which includes a data TLB unit 672 coupled to a data cache unit 674 coupled to a level 2 (L2) cache unit 676. In one exemplary embodiment, the memory access units 664 may include a load unit, a store address unit, and a store data unit, each of which is coupled to the data TLB unit 672 in the memory unit 670. The instruction cache unit 634 is further coupled to a level 2 (L2) cache unit 676 in the memory unit 670. The L2 cache unit 676 is coupled to one or more other levels of cache and eventually to a main memory.

By way of example, the exemplary register renaming, out-of-order issue/execution core architecture may implement the pipeline 600 as follows: 1) the instruction fetch 638 performs the fetch and length decoding stages 602 and 604; 2) the decode unit 640 performs the decode stage 606; 3) the rename/allocator unit 652 performs the allocation stage 608 and renaming stage 610; 4) the scheduler unit(s) 656 performs the schedule stage 612; 5) the physical register file(s) unit(s) 658 and the memory unit 670 perform the register read/memory read stage 614; the execution cluster 660 perform the execute stage 616; 6) the memory unit 670 and the physical register file(s) unit(s) 658 perform the write back/memory write stage 618; 6) various units may be involved in the exception handling stage 622; and 8) the retirement unit 654 and the physical register file(s) unit(s) 658 perform the commit stage 624.

The core 690 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 690 includes logic to support a packed data instruction set extension (e.g., AVX1, AVX2), thereby allowing the operations used by many multimedia applications to be performed using packed data.

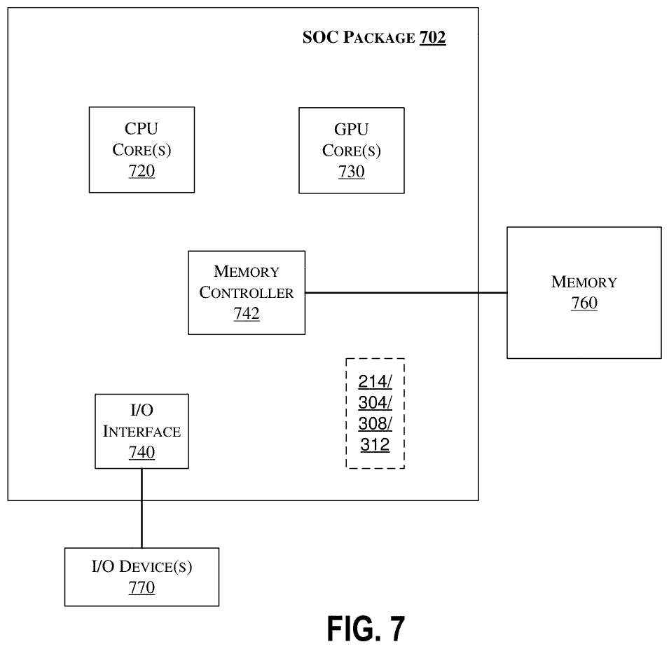

FIG. 7 illustrates a block diagram of an SOC package in accordance with an embodiment. As illustrated in FIG. 7, SOC 702 includes one or more Central Processing Unit (CPU) cores 720, one or more Graphics Processor Unit (GPU) cores 730, an Input/Output (I/O) interface 740, and a memory controller 742. Various components of the SOC package 702 may be coupled to an interconnect or bus such as discussed herein with reference to the other figures. Also, the SOC package 702 may include more or less components, such as those discussed herein with reference to the other figures. Further, each component of the SOC package 702 may include one or more other components, e.g., as discussed with reference to the other figures herein. In one embodiment, SOC package 702 (and its components) is provided on one or more Integrated Circuit (IC) die, e.g., which are packaged into a single semiconductor device.

As illustrated in FIG. 7, SOC package 702 is coupled to a memory 760 via the memory controller 742. In an embodiment, the memory 760 (or a portion of it) can be integrated on the SOC package 702.

The I/O interface 740 may be coupled to one or more I/O devices 770, e.g., via an interconnect and/or bus such as discussed herein with reference to other figures. I/O device(s) 770 may include one or more of a keyboard, a mouse, a touchpad, a display, an image/video capture device (such as a camera or camcorder/video recorder), a touch screen, a speaker, or the like.

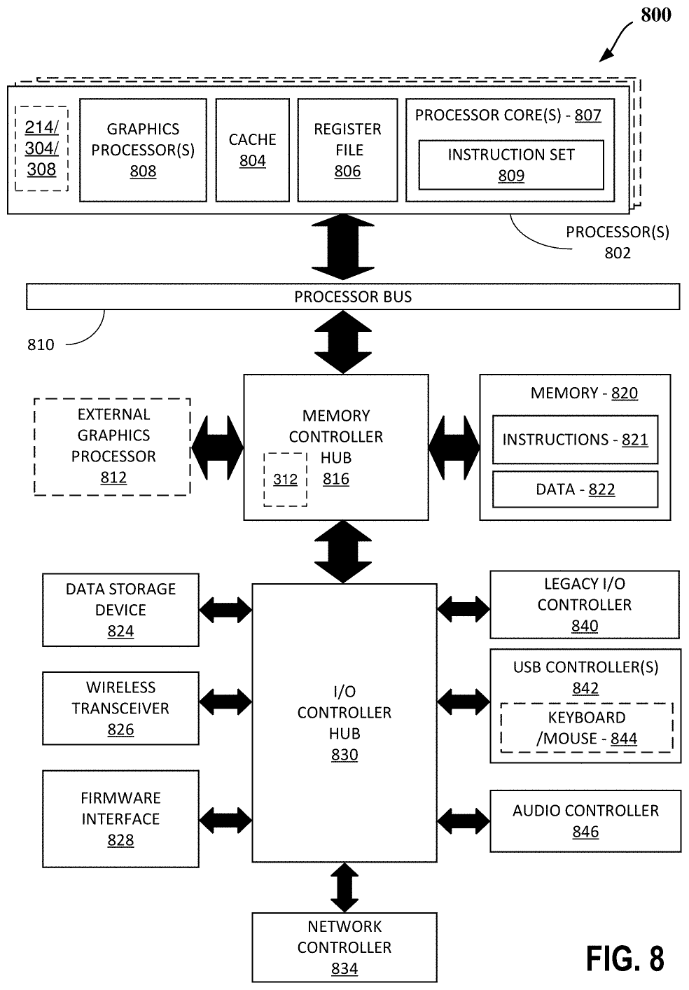

FIG. 8 is a block diagram of a processing system 800, according to an embodiment. In various embodiments the system 800 includes one or more processors 802 and one or more graphics processors 808, and may be a single processor desktop system, a multiprocessor workstation system, or a server system having a large number of processors 802 or processor cores 807. In on embodiment, the system 800 is a processing platform incorporated within a system-on-a-chip (SoC or SOC) integrated circuit for use in mobile, handheld, or embedded devices.

An embodiment of system 800 can include, or be incorporated within a server-based gaming platform, a game console, including a game and media console, a mobile gaming console, a handheld game console, or an online game console. In some embodiments system 800 is a mobile phone, smart phone, tablet computing device or mobile Internet device. Data processing system 800 can also include, couple with, or be integrated within a wearable device, such as a smart watch wearable device, smart eyewear device, augmented reality device, or virtual reality device. In some embodiments, data processing system 800 is a television or set top box device having one or more processors 802 and a graphical interface generated by one or more graphics processors 808.

In some embodiments, the one or more processors 802 each include one or more processor cores 807 to process instructions which, when executed, perform operations for system and user software. In some embodiments, each of the one or more processor cores 807 is configured to process a specific instruction set 809. In some embodiments, instruction set 809 may facilitate Complex Instruction Set Computing (CISC), Reduced Instruction Set Computing (RISC), or computing via a Very Long Instruction Word (VLIW). Multiple processor cores 807 may each process a different instruction set 809, which may include instructions to facilitate the emulation of other instruction sets. Processor core 807 may also include other processing devices, such a Digital Signal Processor (DSP).

In some embodiments, the processor 802 includes cache memory 804. Depending on the architecture, the processor 802 can have a single internal cache or multiple levels of internal cache. In some embodiments, the cache memory is shared among various components of the processor 802. In some embodiments, the processor 802 also uses an external cache (e.g., a Level-3 (L3) cache or Last Level Cache (LLC)) (not shown), which may be shared among processor cores 807 using known cache coherency techniques. A register file 806 is additionally included in processor 802 which may include different types of registers for storing different types of data (e.g., integer registers, floating point registers, status registers, and an instruction pointer register). Some registers may be general-purpose registers, while other registers may be specific to the design of the processor 802.

In some embodiments, processor 802 is coupled to a processor bus 810 to transmit communication signals such as address, data, or control signals between processor 802 and other components in system 800. In one embodiment the system 800 uses an exemplary ‘hub’ system architecture, including a memory controller hub 816 and an Input Output (I/O) controller hub 830. A memory controller hub 816 facilitates communication between a memory device and other components of system 800, while an I/O Controller Hub (ICH) 830 provides connections to I/O devices via a local I/O bus. In one embodiment, the logic of the memory controller hub 816 is integrated within the processor.

Memory device 820 can be a dynamic random access memory (DRAM) device, a static random access memory (SRAM) device, flash memory device, phase-change memory device, or some other memory device having suitable performance to serve as process memory. In one embodiment the memory device 820 can operate as system memory for the system 800, to store data 822 and instructions 821 for use when the one or more processors 802 executes an application or process. Memory controller hub 816 also couples with an optional external graphics processor 812, which may communicate with the one or more graphics processors 808 in processors 802 to perform graphics and media operations.

In some embodiments, ICH 830 enables peripherals to connect to memory device 820 and processor 802 via a high-speed I/O bus. The I/O peripherals include, but are not limited to, an audio controller 846, a firmware interface 828, a wireless transceiver 826 (e.g., Wi-Fi, Bluetooth), a data storage device 824 (e.g., hard disk drive, flash memory, etc.), and a legacy I/O controller 840 for coupling legacy (e.g., Personal System 2 (PS/2)) devices to the system. One or more Universal Serial Bus (USB) controllers 842 connect input devices, such as keyboard and mouse 844 combinations. A network controller 834 may also couple to ICH 830. In some embodiments, a high-performance network controller (not shown) couples to processor bus 810. It will be appreciated that the system 800 shown is exemplary and not limiting, as other types of data processing systems that are differently configured may also be used. For example, the I/O controller hub 830 may be integrated within the one or more processor 802, or the memory controller hub 816 and I/O controller hub 830 may be integrated into a discreet external graphics processor, such as the external graphics processor 812.

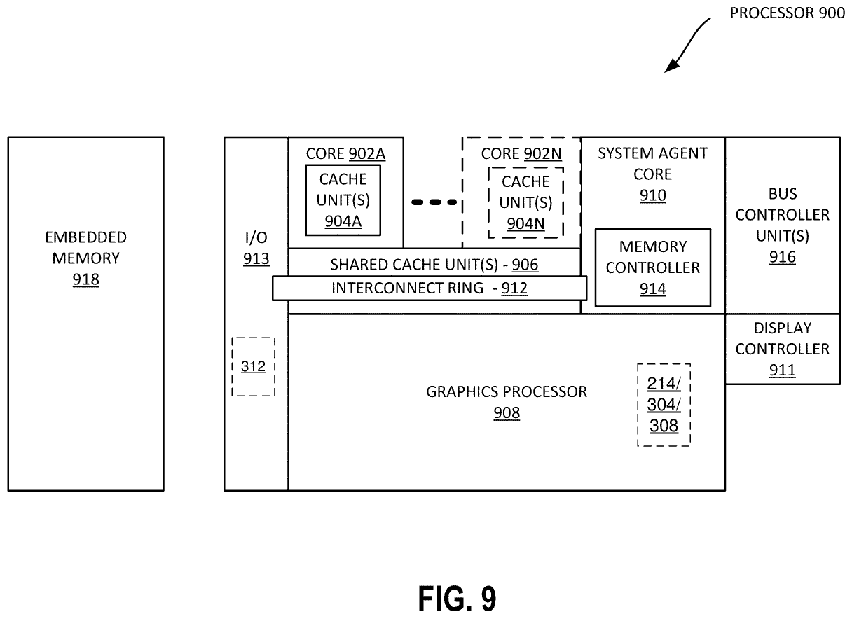

FIG. 9 is a block diagram of an embodiment of a processor 900 having one or more processor cores 902A to 902N, an integrated memory controller 914, and an integrated graphics processor 908. Those elements of FIG. 9 having the same reference numbers (or names) as the elements of any other figure herein can operate or function in any manner similar to that described elsewhere herein, but are not limited to such. Processor 900 can include additional cores up to and including additional core 902N represented by the dashed lined boxes. Each of processor cores 902A to 902N includes one or more internal cache units 904A to 904N. In some embodiments each processor core also has access to one or more shared cached units 906.

The internal cache units 904A to 904N and shared cache units 906 represent a cache memory hierarchy within the processor 900. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 906 and 904A to 904N.

In some embodiments, processor 900 may also include a set of one or more bus controller units 916 and a system agent core 910. The one or more bus controller units 916 manage a set of peripheral buses, such as one or more Peripheral Component Interconnect buses (e.g., PCI, PCI Express). System agent core 910 provides management functionality for the various processor components. In some embodiments, system agent core 910 includes one or more integrated memory controllers 914 to manage access to various external memory devices (not shown).

In some embodiments, one or more of the processor cores 902A to 902N include support for simultaneous multi-threading. In such embodiment, the system agent core 910 includes components for coordinating and operating cores 902A to 902N during multi-threaded processing. System agent core 910 may additionally include a power control unit (PCU), which includes logic and components to regulate the power state of processor cores 902A to 902N and graphics processor 908.

In some embodiments, processor 900 additionally includes graphics processor 908 to execute graphics processing operations. In some embodiments, the graphics processor 908 couples with the set of shared cache units 906, and the system agent core 910, including the one or more integrated memory controllers 914. In some embodiments, a display controller 911 is coupled with the graphics processor 908 to drive graphics processor output to one or more coupled displays. In some embodiments, display controller 911 may be a separate module coupled with the graphics processor via at least one interconnect, or may be integrated within the graphics processor 908 or system agent core 910.

In some embodiments, a ring based interconnect unit 912 is used to couple the internal components of the processor 900. However, an alternative interconnect unit may be used, such as a point-to-point interconnect, a switched interconnect, or other techniques, including techniques well known in the art. In some embodiments, graphics processor 908 couples with the ring interconnect 912 via an I/O link 913.

The exemplary I/O link 913 represents at least one of multiple varieties of I/O interconnects, including an on package I/O interconnect which facilitates communication between various processor components and a high-performance embedded memory module 918, such as an eDRAM (or embedded DRAM) module. In some embodiments, each of the processor cores 902 to 902N and graphics processor 908 use embedded memory modules 918 as a shared Last Level Cache.

In some embodiments, processor cores 902A to 902N are homogenous cores executing the same instruction set architecture. In another embodiment, processor cores 902A to 902N are heterogeneous in terms of instruction set architecture (ISA), where one or more of processor cores 902A to 902N execute a first instruction set, while at least one of the other cores executes a subset of the first instruction set or a different instruction set. In one embodiment processor cores 902A to 902N are heterogeneous in terms of microarchitecture, where one or more cores having a relatively higher power consumption couple with one or more power cores having a lower power consumption. Additionally, processor 900 can be implemented on one or more chips or as an SoC integrated circuit having the illustrated components, in addition to other components.

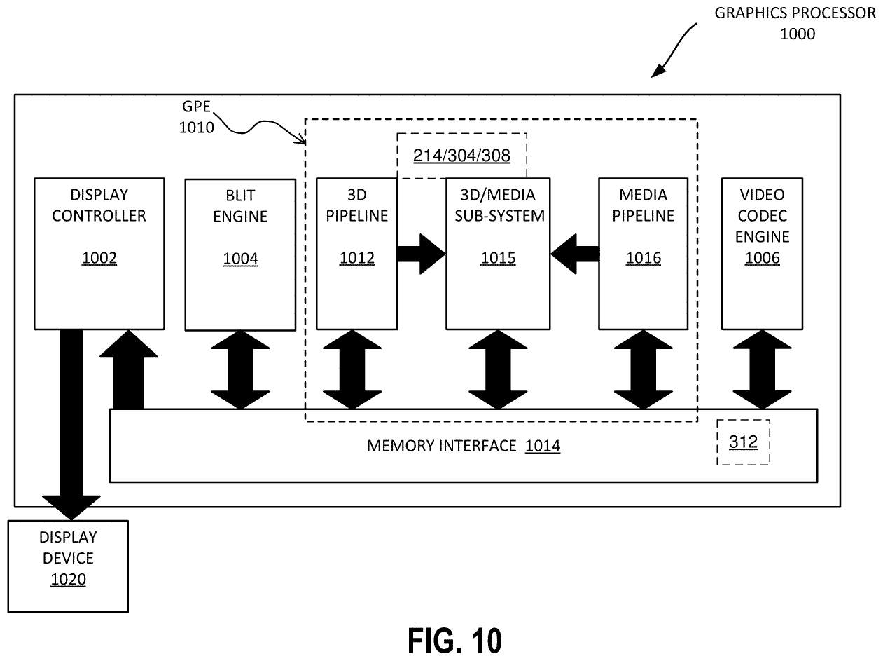

FIG. 10 is a block diagram of a graphics processor 1000, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 1000 includes a memory interface 1014 to access memory. Memory interface 1014 can be an interface to local memory, one or more internal caches, one or more shared external caches, and/or to system memory.

In some embodiments, graphics processor 1000 also includes a display controller 1002 to drive display output data to a display device 1020. Display controller 1002 includes hardware for one or more overlay planes for the display and composition of multiple layers of video or user interface elements. In some embodiments, graphics processor 1000 includes a video codec engine 1006 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 321M/VC-1, and Joint Photographic Experts Group (JPEG) formats such as JPEG, and Motion JPEG (MJPEG) formats.

In some embodiments, graphics processor 1000 includes a block image transfer (BLIT) engine 1004 to perform two-dimensional (2D) rasterizer operations including, for example, bit-boundary block transfers. However, in one embodiment, 3D graphics operations are performed using one or more components of graphics processing engine (GPE) 1010. In some embodiments, graphics processing engine 1010 is a compute engine for performing graphics operations, including three-dimensional (3D) graphics operations and media operations.

In some embodiments, GPE 1010 includes a 3D pipeline 1012 for performing 3D operations, such as rendering three-dimensional images and scenes using processing functions that act upon 3D primitive shapes (e.g., rectangle, triangle, etc.). The 3D pipeline 1012 includes programmable and fixed function elements that perform various tasks within the element and/or spawn execution threads to a 3D/Media sub-system 1015. While 3D pipeline 1012 can be used to perform media operations, an embodiment of GPE 1010 also includes a media pipeline 1016 that is specifically used to perform media operations, such as video post-processing and image enhancement.

In some embodiments, media pipeline 1016 includes fixed function or programmable logic units to perform one or more specialized media operations, such as video decode acceleration, video de-interlacing, and video encode acceleration in place of, or on behalf of video codec engine 1006. In some embodiments, media pipeline 1016 additionally includes a thread spawning unit to spawn threads for execution on 3D/Media sub-system 1015. The spawned threads perform computations for the media operations on one or more graphics execution units included in 3D/Media sub-system 1015.

In some embodiments, 3D/Media subsystem 1015 includes logic for executing threads spawned by 3D pipeline 1012 and media pipeline 1016. In one embodiment, the pipelines send thread execution requests to 3D/Media subsystem 1015, which includes thread dispatch logic for arbitrating and dispatching the various requests to available thread execution resources. The execution resources include an array of graphics execution units to process the 3D and media threads. In some embodiments, 3D/Media subsystem 1015 includes one or more internal caches for thread instructions and data. In some embodiments, the subsystem also includes shared memory, including registers and addressable memory, to share data between threads and to store output data.

In the following description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes an apparatus comprising: a processor having a plurality of processor cores, wherein a logic processor, to be assigned to one of the plurality of processor cores, is to execute one or more operations for at least one of a plurality of logical realms; and the plurality of logical realms to include a security monitor realm, wherein the security monitor realm includes security monitor logic to maintain a Realm Identifier (RID) for each of the plurality of logical realms, the security monitor logic to control access to each of the plurality of realms based at least in part on the RID for each of the plurality of logical realms. Example 2 includes the apparatus of example 1, where the plurality of logical realms comprises an interrupt handler realm to route one or more interrupts to their correct destination realm. Example 3 includes the apparatus of example 2, wherein the one or more interrupts comprise: a local interrupt, an external interrupt, or an inter-processor interrupt. Example 4 includes the apparatus of example 1, further comprising memory to store data in a plurality of partitions, wherein each of the plurality of partitions is accessible by a single one of the plurality logical realms. Example 5 includes the apparatus of example 1, wherein the RID is assigned at a memory page size granularity. Example 6 includes the apparatus of example 1, wherein the plurality of logical realms comprise one or more Virtual Machine Monitor (VMM) realms, wherein each of the one or more VMM realms comprises one or more Virtual Machines (VMs). Example 7 includes the apparatus of example 1, wherein the security monitor logic is to control any communication between the plurality of logical realms. Example 8 includes the apparatus of example 7, wherein the security monitor logic is to control any communication between the plurality of logical realms in response to a VMM entry request or a VMM exit request. Example 9 includes the apparatus of example 1, wherein each memory transaction includes a request RID, wherein an Input-Output Memory Management Unit (IOMMU) is to resolve the request RID during processing of a corresponding memory transaction. Example 10 includes the apparatus of example 1, where the plurality of logical realms comprises an operating system, a bare-metal operating system, or an application realm to provide dedicated hardware resources. Example 11 includes the apparatus of example 1, further comprising an access control data structure to store the RID for each of the plurality of logical realms. Example 12 includes the apparatus of example 1, further comprising a register to store a current RID corresponding to an execution context of the logical processor. Example 13 includes the apparatus of example 12, wherein the current RID is only modifiable by the security monitor logic. Example 14 includes the apparatus of example 1, wherein at least one of the plurality of processor cores is dedicated to execute operations for the security monitor logic to guarantee availability on a periodic or permanent basis. Example 15 includes the apparatus of example 1, wherein one or more of the plurality of logical realms comprise their own coherence domain. Example 16 includes the apparatus of example 1, comprising logic circuitry to isolate a faulty processor core from the plurality of processor cores. Example 17 includes the apparatus of example 1, comprising logic circuitry to map out faulty memory.

Example 18 includes one or more non-transitory computer-readable media comprising one or more instructions that when executed on a processor configure the processor to perform one or more operations to cause: a logic processor, to be assigned to one of a plurality of processor cores of the processor, to execute one or more operations for at least one of a plurality of logical realms, the plurality of logical realms to include a security monitor realm, security monitor logic of the security monitor realm to maintain a Realm Identifier (RID) for each of the plurality of logical realms, the security monitor logic to control access to each of the plurality of realms based at least in part on the RID for each of the plurality of logical realms. Example 19 includes the one or more computer-readable media of example 18, further comprising one or more instructions that when executed on the at least one processor configure the at least one processor to perform one or more operations to cause an interrupt handler realm from the plurality of logical realms to route one or more interrupts to their correct destination realm. Example 20 includes the one or more computer-readable media of example 18, further comprising one or more instructions that when executed on the at least one processor configure the at least one processor to perform one or more operations to cause memory to store data in a plurality of partitions, wherein each of the plurality of partitions is accessible by a single one of the plurality logical realms. Example 21 includes the one or more computer-readable media of example 18, wherein the plurality of logical realms comprise one or more Virtual Machine Monitor (VMM) realms, wherein each of the one or more VMM realms comprises one or more Virtual Machines (VMs). Example 22 includes the one or more computer-readable media of example 18, further comprising one or more instructions that when executed on the at least one processor configure the at least one processor to perform one or more operations to cause the security monitor logic to control any communication between the plurality of logical realms. Example 23 includes the one or more computer-readable media of example 22, further comprising one or more instructions that when executed on the at least one processor configure the at least one processor to perform one or more operations to cause the security monitor logic to control any communication between the plurality of logical realms in response to a VMM entry request or a VMM exit request. Example 24 includes the one or more computer-readable media of example 18, further comprising one or more instructions that when executed on the at least one processor configure the at least one processor to perform one or more operations to cause an Input-Output Memory Management Unit (IOMMU) to resolve a request RID, associated with each memory transaction, during processing of a corresponding memory transaction. Example 25 includes the one or more computer-readable media of example 18, further comprising one or more instructions that when executed on the at least one processor configure the at least one processor to perform one or more operations to cause an access control data structure to store the RID for each of the plurality of logical realms.

Example 26 includes a method comprising: assigning a logic processor to one of a plurality of processor cores of a processor, to execute one or more operations for at least one of a plurality of logical realms, the plurality of logical realms to include a security monitor realm, maintaining, at security monitor logic of the security monitor realm, a Realm Identifier (RID) for each of the plurality of logical realms, the security monitor logic to control access to each of the plurality of realms based at least in part on the RID for each of the plurality of logical realms. Example 27 includes the method of example 26, further comprising causing an interrupt handler realm from the plurality of logical realms to route one or more interrupts to their correct destination realm. Example 28 includes the method of example 26, further comprising storing data in a plurality of partitions of memory, wherein each of the plurality of partitions is accessible by a single one of the plurality logical realms.

Example 29 includes an apparatus comprising means to perform an operation as set forth in any preceding example. Example 30 includes machine-readable storage including machine-readable instructions, when executed, to implement an operation or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In various embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a processor having a plurality of processor cores, wherein a logic processor, to be assigned to one of the plurality of processor cores, is to execute one or more operations for at least one of a plurality of logical realms; and
the plurality of logical realms to include a security monitor realm,
wherein the security monitor realm includes security monitor logic to maintain a Realm Identifier (RID) for each of the plurality of logical realms, the security monitor logic to control access to each of the plurality of realms based at least in part on the RID for each of the plurality of logical realms.

2. The apparatus of claim 1, where the plurality of logical realms comprises an interrupt handler realm to route one or more interrupts to their correct destination realm.

3. The apparatus of claim 2, wherein the one or more interrupts comprise: a local interrupt, an external interrupt, or an inter-processor interrupt.

4. The apparatus of claim 1, further comprising memory to store data in a plurality of partitions, wherein each of the plurality of partitions is accessible by a single one of the plurality logical realms.

5. The apparatus of claim 1, wherein the RID is assigned at a memory page size granularity.

6. The apparatus of claim 1, wherein the plurality of logical realms comprise one or more Virtual Machine Monitor (VMM) realms, wherein each of the one or more VMM realms comprises one or more Virtual Machines (VMs).

7. The apparatus of claim 1, wherein the security monitor logic is to control any communication between the plurality of logical realms.

8. The apparatus of claim 7, wherein the security monitor logic is to control any communication between the plurality of logical realms in response to a VMM entry request or a VMM exit request.

9. The apparatus of claim 1, wherein each memory transaction includes a request RID, wherein an Input-Output Memory Management Unit (IOMMU) is to resolve the request RID during processing of a corresponding memory transaction.

10. The apparatus of claim 1, where the plurality of logical realms comprises an operating system, a bare-metal operating system, or an application realm to provide dedicated hardware resources.

11. The apparatus of claim 1, further comprising an access control data structure to store the RID for each of the plurality of logical realms.

12. The apparatus of claim 1, further comprising a register to store a current RID corresponding to an execution context of the logical processor.

13. The apparatus of claim 12, wherein the current RID is only modifiable by the security monitor logic.

14. The apparatus of claim 1, wherein at least one of the plurality of processor cores is dedicated to execute operations for the security monitor logic to guarantee availability on a periodic or permanent basis.

15. The apparatus of claim 1, wherein one or more of the plurality of logical realms comprise their own coherence domain.

16. The apparatus of claim 1, comprising logic circuitry to isolate a faulty processor core from the plurality of processor cores.

17. The apparatus of claim 1, comprising logic circuitry to map out faulty memory.

18. One or more non-transitory computer-readable media comprising one or more instructions that when executed on a processor configure the processor to perform one or more operations to cause:
a logic processor, to be assigned to one of a plurality of processor cores of the processor, to execute one or more operations for at least one of a plurality of logical realms, the plurality of logical realms to include a security monitor realm,
security monitor logic of the security monitor realm to maintain a Realm Identifier (RID) for each of the plurality of logical realms, the security monitor logic to control access to each of the plurality of realms based at least in part on the RID for each of the plurality of logical realms.

19. The one or more computer-readable media of claim 18, further comprising one or more instructions that when executed on the at least one processor configure the at least one processor to perform one or more operations to cause an interrupt handler realm from the plurality of logical realms to route one or more interrupts to their correct destination realm.

20. The one or more computer-readable media of claim 18, further comprising one or more instructions that when executed on the at least one processor configure the at least one processor to perform one or more operations to cause memory to store data in a plurality of partitions, wherein each of the plurality of partitions is accessible by a single one of the plurality logical realms.

21. The one or more computer-readable media of claim 18, wherein the plurality of logical realms comprise one or more Virtual Machine Monitor (VMM) realms, wherein each of the one or more VMM realms comprises one or more Virtual Machines (VMs).

22. The one or more computer-readable media of claim 18, further comprising one or more instructions that when executed on the at least one processor configure the at least one processor to perform one or more operations to cause the security monitor logic to control any communication between the plurality of logical realms.

23. The one or more computer-readable media of claim 22, further comprising one or more instructions that when executed on the at least one processor configure the at least one processor to perform one or more operations to cause the security monitor logic to control any communication between the plurality of logical realms in response to a VMM entry request or a VMM exit request.

24. The one or more computer-readable media of claim 18, further comprising one or more instructions that when executed on the at least one processor configure the at least one processor to perform one or more operations to cause an Input-Output Memory Management Unit (IOMMU) to resolve a request RID, associated with each memory transaction, during processing of a corresponding memory transaction.

25. The one or more computer-readable media of claim 18, further comprising one or more instructions that when executed on the at least one processor configure the at least one processor to perform one or more operations to cause an access control data structure to store the RID for each of the plurality of logical realms.
